(19) United States
(12) Patent Application Publication
(10) Pub. No.: US 2026/0318784 A1
(43) Pub. Date: Oct. 15, 2026

(54) METHOD AND SYSTEM FOR SWAY EVALUATION OF SUSPENDED TRAIN

(71) Applicant: GA SKYTRAIN MOBILITY GROUP, LLC, Peachtree Corners, GA (US)

(72) Inventors: XIUGAO ZHANG, Xuanhan City (CN); WEIFENG TANG, Jiangyin City (CN); HUAZHONG LIU, Jiangyin City (CN); HAOTIAN ZHANG, Jiange City (CN)

(21) Appl. No.: 19/318,628

(22) Filed: Sep. 4, 2025

(30) Foreign Application Priority Data
Dec. 2, 2024 (CN) 202411745956.4

(51) Int. Cl. G01M 17/08; B61B 3/00; B61B 13/04; G06N 3/126

(52) U.S. Cl. CPC G01M 17/08; B61B 3/00; B61B 13/04; G06N 3/126

(57) ABSTRACT

The invention discloses the method and system for sway evaluation of a suspended train. The invention utilizes the operating parameters and status of the suspended train in a turning state to construct a dynamic model and calculate the sway degree, which can effectively evaluate the sway degree of the suspended train in the turning state, further assist the cab/driver in controlling the suspended train, efficiently detect potential safety hazards and provide strong guarantees for the comfort and safety of train operation

### CROSS-REFERENCE TO RELATED PATENT APPLICATION

This application claims priority to and the benefit of Chinese Patent Application Serial No. 202411745956.4, filed Dec. 2, 2024, which is incorporated herein in its entirety by reference

### FIELD OF THE INVENTION

The present invention relates generally to the field of train management, and more particularly to the method and system for the sway evaluation of a suspended train.

### BACKGROUND OF THE INVENTION

With the increasing pressure of urban traffic, traditional ground train systems are no longer able to meet people's growing needs. As a new type of transportation, suspended trains have received widespread attention and research in recent years due to their advantages of high efficiency and energy conservation. However, ensuring the safe and stable operation of the suspended train under various working conditions still faces many challenges.

Currently, research on suspended trains focuses primarily on design and manufacturing, such as optimizing the design of train suspension systems and operating control strategies. However, how to monitor and evaluate the running status of trains in real time during actual operation to ensure safe, stable, and comfortable operation of trains is still an urgent problem to be solved. When a suspended train enters a bend, passengers and other items may be greatly affected due to changes in the inclination angle of the carriage, such as seasickness, weightlessness, or overweight. These factors may have a certain impact on the comfort experience of passengers, and may even endanger the safety of some passengers. Therefore, a method and system for sway evaluation of the suspended train are needed, which can obtain the sway evaluation results and provide feedback to the cab, effectively improving passenger comfort and safety.

### SUMMARY OF THE INVENTION

The purpose of the present invention is to provide a method and system for sway evaluation of a suspended train, in order to improve the above-mentioned technical problems. In order to achieve the above invention objectives, the embodiment of the present invention provides the following technical solutions: a method for sway evaluation of a suspended train, comprising: step S1, obtaining historical operating data of the suspended train under different working conditions; The historical operational data includes driving speed, acceleration, angular velocity, tilt angle, passenger capacity, maximum radial force, turning arc length, turning angle, train parameters, and track geometry parameters; The train parameters include slope and curve radius; The track geometry parameters include train length, train width, train height, and train wheelbase; step S2, Based on historical operating data, construct a dynamic model corresponding to the suspended train and determine the corresponding operating coefficient; step S3, Obtain the operational status data of the suspended train currently in a turning scenario; The operational status data includes the speed, acceleration, angular velocity, tilt angle, passenger capacity, maximum radial force, turning arc length, and turning angle of the suspended train currently in a turning scenario; step S4, Based on the operational status data, calculate the corresponding sway degree value, wherein the formula for the sway degree value is:

$$W = \frac{\sqrt{( {λ}_{1} \cdot {a}^{2} + {ς}_{1} \cdot {θ}^{2} + {η}_{1} \cdot {w}^{2} ) \cdot ( 1 - {e}^{- ( {λ}_{2} \cdot {v}^{2} + {ς}_{2} \cdot {Fr}^{2} )} )}}{L} \cdot P \cdot cos α ;$$

wherein λ₁, ζ₁, η₁, λ₂, ζ₂ respectively represent acceleration coefficient, inclination angle coefficient, angular velocity coefficient, running speed coefficient, and maximum radial force coefficient. a represents the acceleration of the suspended train currently in a turning scenario, θ represents the inclination angle of the suspended train currently in a turning scenario, [symbol] represents the angular velocity of the suspended train currently in a turning scenario, e represents a natural constant, Fr represents the maximum radial force of the suspended train currently in a turning scenario, ν represents the speed of the suspended train currently in a turning scenario, L represents the turning arc length of the suspended train currently in a turning scenario, P represents the passenger capacity of the suspended train currently in a turning scenario, α represents the turning angle of the suspended train currently in a turning scenario, W indicating the sway degree value; S5, Determine the sway degree based on the sway evaluation rule and obtain the corresponding sway evaluation result. The sway evaluation rule is: when the sway degree value does not exceed the first threshold, the corresponding sway evaluation result is no sensation or slight swaying; when the sway degree value is greater than the first threshold and does not exceed the second threshold, the corresponding sway evaluation result is light swaying; when the sway degree value is greater than the second threshold and does not exceed the third threshold, the corresponding sway evaluation result is moderate swaying; when the sway degree value is greater than the third threshold and does not exceed the fourth threshold, the corresponding sway evaluation result is strong swaying; when the sway degree value is greater than the fourth threshold but does not exceed the fifth threshold, the corresponding sway evaluation result is severe swaying.

Based on the historical operating data, constructing the dynamic model corresponding to the suspended train and determining the corresponding operating coefficient, includes: step S2-1, using multiple dynamic software to construct the corresponding dynamic model; step S2-2, inputting the processed historical operational data into the dynamic model for simulation, and obtaining corresponding simulation results; step S2-3, based on the simulation results, determining the operating coefficient using a genetic algorithm; wherein the operating coefficients include an acceleration coefficient λ₁, a tilt angle coefficient ζ₁, an angular velocity coefficient η₁, a driving speed coefficient λ₂, and a maximum radial force coefficient ζ₂.

Based on the simulation results, using genetic algorithm to determine the operating coefficient includes: step S2-3-1, calculating the error function based on the simulation results; step S2-3-2, randomly generating a set of running coefficients and using them as the race; step S2-3-3, based on the error function, calculating the fitness of each individual in the race; step S2-3-4, based on the fitness, selecting individuals as outstanding individuals; crossing and mutating outstanding individuals; step S2-3-5, repeating steps step S2-3-3 to step S2-3-4 until the preset number of iterations is reached to obtain the operating coefficient.

The process of obtaining the operational status data of a suspended train currently in a turning scenario includes: step S3-1, measuring the speed, acceleration, angular velocity, and tilt angle of the suspended train currently in a turning scenario through sensors and gyroscopes installed at the top of the train; step S3-2, obtaining the historical operational data of the suspended train; and based on the current time period and historical operational data, determining the passenger capacity for the current time period; step S3-3, determining the turning arc length and turning angle through the track geometry parameters; step S3-4, constructing a dynamic model of the suspended monorail track system and conducti simulation analysis to obtain the maximum radial force.

A system for sway evaluation of a suspended train comprises an operation data acquisition module, an operation coefficient determination module, a sway degree calculation module, and a sway evaluation result acquisition module. The operation data acquisition module is used to obtain historical operation data of the suspended train under different working conditions and the operation status data of the suspended train currently in turning scenarios. The operation coefficient determination module is used to construct the corresponding dynamic model of the suspended train based on historical operating data and determine the corresponding operating coefficient. The sway degree calculation module is used to calculate the corresponding sway degree value based on operating status data. The sway evaluation result acquisition module is used to determine the sway degree based on the sway evaluation rule and obtain the corresponding sway evaluation result.

The sway evaluation system also includes a display module for feeding back the sway degree value and sway evaluation result to the cab and displaying them on the dashboard.

The beneficial effects of the present invention are as follows: this method utilizes the operating parameters and status of the suspended train in a turning state to construct a dynamic model and calculate the sway degree, which can effectively evaluate the sway degree of the suspended train in a turning state, further assist the cab/driver in controlling the suspended train, detect potential safety hazards in a timely fashion, and provide strong guarantees for the comfort and safety of train operation. This system monitors the real-time operation status of the suspended train, accurately obtains the sway degree value, and feeds it back to the cab, allowing the driver to efficiently understand the movement of the suspended train under turning conditions, improving the safety and comfort of the train.

### BRIEF DESCRIPTION OF THE DRAWINGS

In order to more clearly illustrate the technical solutions of the embodiments of the present invention, the following briefly introduces the drawings required for use in the embodiments. It should be understood that the following drawings only illustrate certain embodiments of the present invention and should not be regarded as limiting the scope. For those skilled in the art, other relevant drawings can be obtained based on these drawings without creative work.

FIG. 1 is a flowchart of a method in an embodiment of the present invention.

FIG. 2 is a system diagram in an embodiment of the present invention.

### DETAILED DESCRIPTION OF THE INVENTION

The technical solutions in the embodiments of the present invention will be clearly and completely described below in conjunction with the drawings in the embodiments of the present invention. Obviously, the described embodiments are only a part of the embodiments of the present invention, not all of the embodiments. The components of the embodiments of the present invention generally described and shown in the drawings herein can be arranged and designed in various different configurations. Therefore, the following detailed description of the embodiments of the present invention provided in the drawings is not intended to limit the scope of the claimed invention, but merely represents selected embodiments of the present invention. Based on the embodiments of the present invention, all other embodiments obtained by those skilled in the art without making creative work are within the scope of protection of the present invention.

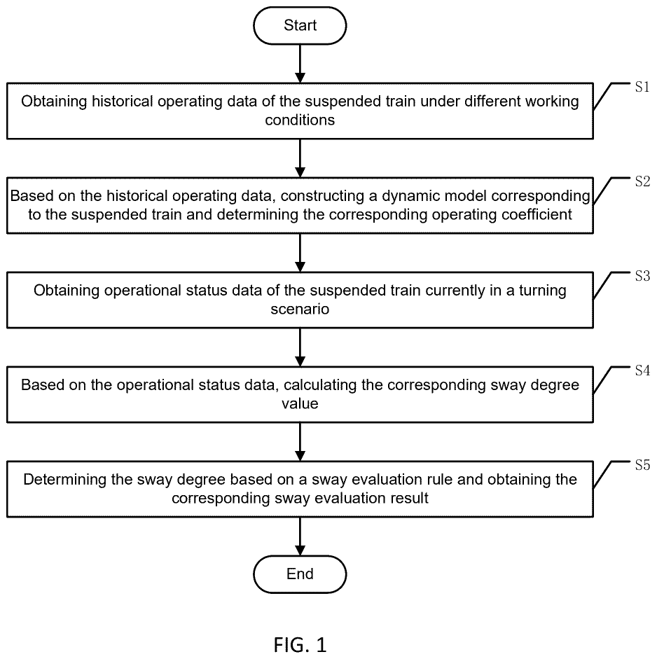

Refer to FIG. 1, a method for sway evaluation of a suspended train is shown according to one embodiment of the invention, which includes: step S1, obtaining historical operating data of the suspended train under different working conditions. The historical operational data includes driving speed, acceleration, angular velocity, tilt angle, passenger capacity, maximum radial force, turning arc length, turning angle, train parameters, and track geometry parameters; The train parameters include slope and curve radius; The track geometry parameters include train length, train width, train height, and train wheelbase. Historical operational data needs to be preprocessed; Preprocessing includes but is not limited to data cleaning, anomaly detection, denoising and normalization.

Step S2, based on the historical operating data, constructs a dynamic model corresponding to the suspended train and determines the corresponding operating coefficient.

Step S2 includes: step S2-1, constructing the corresponding dynamic model using multiple dynamic software; The basic formula of the dynamic model is: F=M\ddot{x}+C\dot{x}+Kx; wherein F represents the external force vector of the suspended train during turning, x represents the state vector of the suspended train during turning, including historical operating data, \dot{x}, \ddot{x} respectively represents the first and second derivatives of the state vector x, M represents the mass matrix of the suspended train during turning, C represents the damping matrix of the suspended train during turning, K represents the stiffness matrix of the suspended train when turning.

The dynamic model can also use other formulas, but since this part is selected in the corresponding existing technical means, it will not be elaborated further.

Step S2-2, inputting the processed historical operational data into the dynamic model for simulation, and obtain corresponding simulation results.

Step S2-3, based on the simulation results, using genetic algorithm to determine the operating coefficient.

The specific steps corresponding to step S2-3 are as follows: step S2-3-1, calculating the error function based on the simulation results; wherein the average absolute error function is selected as the error function.

Step S2-3-2, randomly generating a set of running coefficients and use them as the race.

Step S2-3-3, calculating the fitness of each individual in the race based on the error function. The formula for fitness is:

$$S ( x ) = \frac{1}{E ( x )} ;$$

wherein E(x) represents the error function and S(x) represents fitness.

Step S2-3-4, based on fitness, selecting individuals as outstanding individuals; crossing and mutating outstanding individuals.

Step S2-3-5, repeating the steps step S2-3-3 to step S2-3-4 until the preset number of iterations is reached to obtain the operating coefficient.

The operating coefficients include acceleration coefficient λ₁, tilt angle coefficient ζ₁, angular velocity coefficient η₁, driving speed coefficient λ₂, and maximum radial force coefficient ζ₂.

step S3, obtaining the operational status data of the suspended train currently in a turning scenario. The operational status data includes the speed, acceleration, angular velocity, tilt angle, passenger capacity, maximum radial force, turning arc length, and turning angle of the suspended train currently in a turning scenario.

The process of obtaining operational status data of a suspended train currently in a turning scenario includes: step S3-1, measuring the speed, acceleration, angular velocity, and tilt angle of the suspended train currently in a turning scenario through sensors and gyroscopes installed at the top of the train.

Step S3-2, obtaining historical operational data of the suspended train; based on the current time period and historical operational data, determining the passenger capacity for the current time period. The specific process is to match the timestamp of the current time period with the timestamp of the historical operational data to obtain multiple identical time periods corresponding to different dates; process the passenger capacity corresponding to multiple identical time periods; considering the scheduling of peak commuting hours and holidays, multiple passenger capacity is processed using weighted averaging to obtain the passenger capacity for the current time period. The historical operational data refers to the passenger capacity of the suspended train at different time periods and their corresponding timestamps.

Step S3-3, determining the turning arc length and turning angle through the track geometry parameters.

Step S3-4, constructing a dynamic model of the suspended monorail track system and conducting simulation analysis to obtain the maximum radial force.

Step S4, based on the operational status data, calculating the corresponding sway degree value. The formula for the sway degree value is:

$$W = \frac{\sqrt{( {λ}_{1} \cdot {a}^{2} + {ς}_{1} \cdot {θ}^{2} + {η}_{1} \cdot {w}^{2} ) \cdot ( 1 - {e}^{- ( {λ}_{2} \cdot {v}^{2} + {ς}_{2} \cdot {Fr}^{2} )} )}}{L} \cdot P \cdot cos α ;$$

wherein λ₁, ζ₁, η₁, λ₂, ζ₂ respectively represent acceleration coefficient, inclination angle coefficient, angular velocity coefficient, running speed coefficient, and maximum radial force coefficient. α represent the acceleration of the suspended train currently in a turning scenario, θ represents the inclination angle of the suspended train currently in a turning scenario, [symbol] represents the angular velocity of the suspended train currently in a turning scenario, e represents the natural constant, Fr represents the maximum radial force of the suspended train currently in a turning scenario, ν represents the running speed of the suspended train currently in a turning scenario, L represents the turning arc length of the suspended train currently in a turning scenario, P represents the passenger capacity of the suspended train currently in a turning scenario, α represents the turning angle of the suspended train currently in a turning scenario, W represents the sway degree.

Step S5, based on the sway evaluation rule, determining the sway degree value and obtaining the corresponding sway evaluation result.

The sway evaluation rule is: when the sway degree value does not exceed the first threshold, the corresponding sway evaluation result is no sensation or slight swaying; when the sway degree value is greater than the first threshold and does not exceed the second threshold, the corresponding sway evaluation result is light swaying; When the sway degree value is greater than the second threshold and does not exceed the third threshold, the corresponding sway evaluation result is moderate swaying; when the sway degree value is greater than the third threshold and does not exceed the fourth threshold, the corresponding sway evaluation result is strong swaying; when the sway degree value is greater than the fourth threshold but does not exceed the fifth threshold, the corresponding sway evaluation result is severe swaying. Wherein the first to fifth thresholds are formulated according to actual needs, and the sizes of the first to fifth thresholds vary in different environments and weather conditions.

In addition, this method includes: step S6, transmitting the sway evaluation results and sway evaluation values to the cab; wherein the evaluation results of different levels of swaying are displayed in different colors, so that the driver can detect the sway degree of the train in a turning situation at the first instance, and adjust the train speed or reduce the fuel supply according to experience and regulations.

This method utilizes the operating parameters and status of the suspended train in the turning state to construct a dynamic model and calculate the sway degree, which can effectively evaluate the sway degree of the suspended train in the turning state, further assist the cab/driver in controlling the suspended train, efficiently discover potential safety hazards, and provide strong guarantees for the comfort and safety of train operation

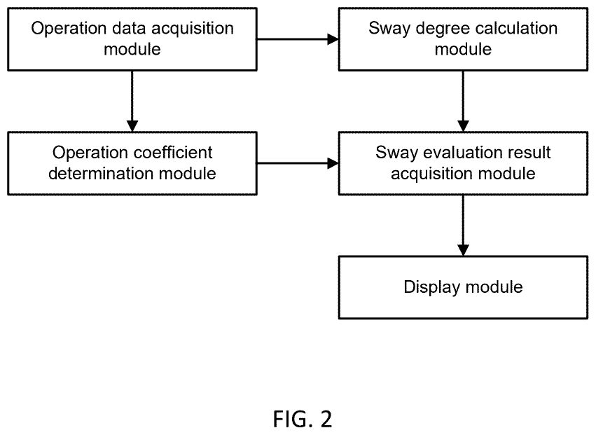

As shown in FIG. 2, a suspension train sway evaluation system includes a suspension train operation data acquisition module, a suspension train operation coefficient determination module, a suspension train sway degree calculation module, and a suspension train sway evaluation result acquisition module; wherein the suspended train operation data acquisition module is used to obtain historical operation data of the suspended train under different working conditions and the operation status data of the suspended train currently in a turning scenario; the suspension train operation coefficient determination module is used to construct the corresponding dynamic model of the suspended train based on the historical operating data and determine the corresponding operating coefficient; the suspended train sway degree calculation module, used to calculate the corresponding sway degree value based on operating status data; and the suspension train sway evaluation result acquisition module is used to determine the sway degree based on the sway evaluation rule and obtain the corresponding sway evaluation result. The sway evaluation system also includes a display module for feeding back the sway degree value and sway evaluation result to the cab and displaying them on the dashboard.

This system monitors the real-time operation status of the suspended train, accurately obtains the sway degree value, and feeds it back to the cab, allowing the driver to quickly understand the movement of the suspended train under turning conditions, improving the safety and comfort of the train.

The above is only a specific embodiment of the present invention, but the scope of protection of the present invention is not limited to this. Any skilled person familiar with the technical field can easily think of changes or substitutions within the technical scope disclosed in the present invention, which should be included in the scope of protection of the present invention. Therefore, the scope of protection of the present invention should be based on the scope of protection of the claims.

What is claimed is:

1. A method for sway evaluation of a suspended train, comprising:
step S1, obtaining historical operating data of the suspended train under different working conditions; wherein the historical operational data includes driving speed, acceleration, angular velocity, tilt angle, passenger capacity, maximum radial force, turning arc length, turning angle, train parameters, and track geometry parameters; wherein the train parameters include slope and curve radius; and wherein the track geometry parameters include train length, train width, train height, and train wheelbase;
step S2, based on the historical operating data, constructing a dynamic model corresponding to the suspended train and determining the corresponding operating coefficient;
step S3, obtaining operational status data of the suspended train currently in a turning scenario; wherein the operational status data includes the speed, acceleration, angular velocity, tilt angle, passenger capacity, maximum radial force, turning arc length, and turning angle of the suspended train currently in a turning scenario;
step S4, based on the operational status data, calculating the corresponding sway degree value; wherein the sway degree value satisfies the following formula:
$$W = \frac{\sqrt{( {λ}_{1} \cdot {a}^{2} + {ς}_{1} \cdot {θ}^{2} + {η}_{1} \cdot {w}^{2} ) \cdot ( 1 - {e}^{- ( {λ}_{2} \cdot {v}^{2} + {ς}_{2} \cdot {Fr}^{2} )} )}}{L} \cdot P \cdot cos α ;$$
wherein λ₁, ζ₁, η₁, λ₂, ζ₂ respectively represent acceleration coefficient, inclination angle coefficient, angular velocity coefficient, running speed coefficient, and maximum radial force coefficient. α represents the acceleration of the suspended train currently in a turning scenario, θ represents the inclination angle of the suspended train currently in a turning scenario, [symbol] represents the angular velocity of the suspended train currently in a turning scenario, e represents a natural constant, Fr represents the maximum radial force of the suspended train currently in a turning scenario, ν represents the speed of the suspended train currently in a turning scenario, L represents the turning arc length of the suspended train currently in a turning scenario, P represents the passenger capacity of the suspended train currently in a turning scenario, α represents the turning angle of the suspended train currently in a turning scenario, W indicating the sway degree value; and
step S5, determining the sway degree based on a sway evaluation rule and obtaining the corresponding sway evaluation result; wherein the sway evaluation rule is:
when the sway degree value does not exceed a first threshold, the corresponding sway evaluation result is “no sensation or slight swaying”;
when the sway degree value is greater than the first threshold and does not exceed a second threshold, the corresponding sway evaluation result is “light swaying”;
when the sway degree value is greater than the second threshold and does not exceed a third threshold, the corresponding sway evaluation result is “moderate swaying”;
when the sway degree value is greater than the third threshold and does not exceed a fourth threshold, the corresponding sway evaluation result is “strong swaying”; and
when the sway degree value is greater than the fourth threshold but does not exceed a fifth threshold, the corresponding sway evaluation result is “severe swaying”.

2. The method of claim 1, wherein the step S2 comprises:
step S2-1, using multiple dynamic software to construct the corresponding dynamic model;
step S2-2, inputting the processed historical operational data into the dynamic model for simulation, and obtain corresponding simulation results; and
step S2-3, based on the simulation results, determining the operating coefficient using a genetic algorithm;
wherein the operating coefficient includes an acceleration coefficient λ₁, a tilt angle coefficient ζ₁, an angular velocity coefficient η₁, a driving speed coefficient λ₂, a maximum radial force coefficient ζ₂.

3. The method of claim 2, wherein the operating coefficient is determined using the genetic algorithm based on the simulation results comprises:
step S2-3-1, calculating an error function based on the simulation results;
step S2-3-3, based on the error function, calculating the fitness of each individual in the race;
step S2-3-4, based on the fitness, selecting individuals as outstanding individuals; crossing and mutating outstanding individuals; and
step S2-3-5, repeating the steps step S2-3-3 to step S2-3-4 until the preset number of iterations is reached to obtain the operating coefficient.

4. The method of claim 1, wherein obtaining operational status data of the suspended train currently in a turning scenario comprises:
step S3-1, measuring the traveling speed, acceleration, angular velocity, and tilt angle of the suspended train currently in a turning scenario through sensors and gyroscopes installed at the top of the train;
step S3-2, obtaining the historical operational data of the suspended train; based on the current time period and historical operational data, determining the passenger capacity for the current time period;
step S3-3, determining the turning arc length and turning angle through the track geometry parameters; and
step S3-4, constructing a dynamic model of the suspended monorail track system and conducting simulation analysis to obtain the maximum radial force.

5. A system for sway evaluation of a suspended train, used to implement the method of claim 1, comprising:
an operation data acquisition module, an operation coefficient determination module, a sway degree calculation module, and a sway evaluation result acquisition module; wherein:
the operation data acquisition module is used to obtain the historical operation data of the suspended train under different working conditions and the operation status data of the suspended train currently in turning scenarios;
the operation coefficient determination module is used to construct the corresponding dynamic model of the suspended train based on historical operating data and determine the corresponding operating coefficient;
the sway degree calculation module is used to calculate the corresponding sway degree value based on operating status data; and
the sway evaluation result acquisition module is used to determine the sway degree based on the sway evaluation rule and obtain the corresponding sway evaluation result.

6. The system of claim 5, further comprising a display module for feeding back the sway degree value and the sway evaluation result to the cab and displaying them on the dashboard.
